(19) United States
(12) Patent Application Publication
(10) Pub. No.: US 2014/0318213 A1
(43) Pub. Date: Oct. 30, 2014

(54) TEST APPARATUS AND TEST METHOD FOR ACOUSTIC MICRO-DEVICE

(71) Applicant: Solid State System Co., Ltd., Hsinchu (TW)

(72) Inventors: Li-Chi Tsao, Taichung (TW); Chien-Hsing Lee, Hsinchu County (TW)

(21) Appl. No.: 13/929,810

(22) Filed: Jun. 28, 2013

(30) Foreign Application Priority Data
Apr. 26, 2013 (TW) 102115097

(51) Int. Cl. G01N 29/30

(52) U.S. Cl. CPC G01N 29/30
USPC 73/1.86

(57) ABSTRACT

An acoustic micro-device testing apparatus including an acoustic device, at least one device under test (DUT), and a bearing plate is disclosed. The acoustic device provides a testing acoustic source to a first side of the DUT through the main channel and to a second side of the DUT through the side channel. The bearing plate has a first surface and a second surface. The first surface has a chamber sunken into the bearing plate. The second surface has a bearing space sunken into the bearing plate and bearing the DUT. The bearing plate has a main channel connecting the chamber and the DUT and at least one side channel connecting the chamber and the bearing space directly or through the main channel. A cover unit covers the bearing plate so that the bearing space and the chamber form a confined space. The DUT is in the confined space.

### CROSS-REFERENCE TO RELATED APPLICATION

This application claims the priority benefit of Taiwan application serial no. 102115097, filed on Apr. 26, 2013. The entirety of the above-mentioned patent application is hereby incorporated by reference herein and made a part of this specification.

### BACKGROUND OF THE INVENTION

1. Field of the Invention

The present invention generally relates to the test of a micro-device, and more particularly, to a test apparatus and a test method for an acoustic micro-device.

2. Description of Related Art

The development of semiconductor manufacturing technology allows semiconductors to be integrated with mechanical systems into micro-electromechanical systems (MEMS). Namely, MEMS is an industrial technology which combines microelectronical technology and mechanical engineering.

After an acoustic micro-device (for example, a MEMS microphone) in an MEMS application is manufactured, the noise level of the acoustic micro-device is usually tested. However, because acoustic micro-devices are prone to be interfered by environmental factors (for example, vibration, noises, temperature, humidity, and pressure), when the intrinsic noise of a device under test (DUT) is tested, the interference of the environmental factors may cause the measurement of the intrinsic noise to be inaccurate. Even though the DUT can be tested in an environment in which all the environmental factors are isolated, it is difficult and inconvenient to maintain such an isolated testing environment when a large quantity of DUTs is tested.

### SUMMARY OF THE INVENTION

Accordingly, the present invention is directed to a testing apparatus for an acoustic micro-device, in which the intrinsic noise of the acoustic micro-device can be thoroughly tested.

The present invention is also directed to a testing method for an acoustic micro-device, in which the interference of environmental factors is effectively eliminated even when a micro-device testing apparatus is in a non-isolated environment.

The present invention provides a testing apparatus for an acoustic micro-device. The testing apparatus includes an acoustic device, at least one device under test (DUT), and a bearing plate. The acoustic device provides a testing acoustic source. The bearing plate has a first surface and a second surface. The first surface has a chamber sunken into the bearing plate, and the second surface has a bearing space sunken into the bearing plate and bearing the DUT. The bearing plate further has a main channel connecting the chamber with the DUT, and at least one side channel connecting the chamber with the bearing space directly or through the main channel. The testing acoustic source is provided to a first side of the DUT through the main channel and to a second side of the DUT through the side channel. A cover unit covers the bearing plate, so that the bearing space and the chamber form a confined space. The DUT is in the confined space.

The present invention provides a testing method for an acoustic micro-device. The testing method includes following steps. A reference test device is selected. A reference noise Na of the reference test device is measured in an anechoic environment. In a same testing environment, an acoustic source is provided to the reference test device and at least one DUT, and sensing signals of the reference test device and the DUT to the acoustic source are measured to respectively obtain a first noise Nb of the reference test device and a second noise Nc of the DUT. An intrinsic noise Nd of the DUT is calculated, where the reference noise Na, the first noise Nb, the second noise Nc, and the intrinsic noise Nd satisfy following relationship:

Nd=Nc−(Nb−Na).

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a compensative acoustic micro-device testing mechanism according to an embodiment of the present invention.

FIG. 2 is a diagram of a compensative acoustic micro-device testing apparatus according to an embodiment of the present invention.

FIG. 3 is a flowchart of a compensative acoustic micro-device testing method according to an embodiment of the present invention.

FIG. 4A is a partial top view of an acoustic micro-device testing apparatus according to an embodiment of the present invention.

FIG. 4B is a cross-sectional view of the acoustic micro-device testing apparatus in FIG. 4A along line I-I′ according to an embodiment of the present invention.

FIG. 4C is a cross-sectional view of the acoustic micro-device testing apparatus in FIG. 4A along line II-IF according to an embodiment of the present invention.

FIG. 5A is a diagram illustrating the acoustic frequency response of a defective acoustic micro-device tested by using a testing apparatus without a side channel according to an embodiment of the present invention.

FIG. 5B is a diagram illustrating the acoustic frequency response of a defective acoustic micro-device tested by using a testing apparatus with a side channel according to an embodiment of the present invention.

FIG. 6A is a partial top view of an acoustic micro-device testing apparatus according to an embodiment of the present invention.

FIG. 6B is a cross-sectional view of the acoustic micro-device testing apparatus in FIG. 6A along line A-A′ according to an embodiment of the present invention.

FIG. 7 is an exploded cross-sectional view of a plurality of device under tests (DUT) on a wafer tested by an acoustic micro-device testing apparatus according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

An acoustic test needs to be performed on a MEMS device, such as a MEMS acoustic sensor or a MEMS microphone, to determine the sensitivity and noise level of the MEMS device. The present invention provides a mechanism capable of testing DUT effectively.

Several exemplary embodiments of the present invention will be described below. However, these exemplary embodiments are not intended to limit the scope of the present invention and can be combined without departing the scope and spirit of the present invention.

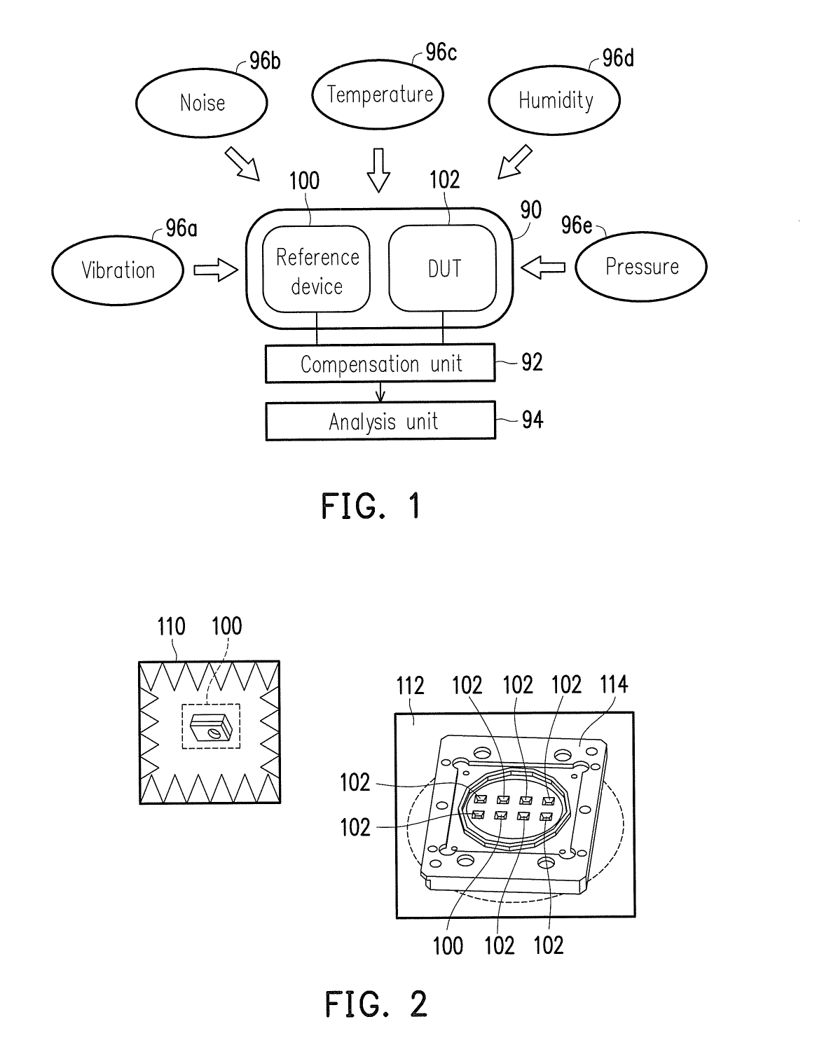

FIG. 1 is a diagram of a compensative acoustic micro-device testing mechanism according to an embodiment of the present invention. Referring to FIG. 1, a reference device 100 and a DUT 102 of the same structure are placed in the same testing environment 90. The reference device 100 and the DUT 102 may be circuit chips after the packaging and cutting processes, and the numbers thereof are determined according to the actual design requirement. In the present embodiment, the numbers of the reference device 100 and the DUT 102 are respectively assumed to be 1. When the reference device 100 and the DUT 102 are tested, the testing environment 90 receives various environmental noises, such as a vibration 96a, an environmental noise 96b, a temperature 96c, a humidity 96d, and a pressure 96e. All these environmental noises will affect the testing result of the reference device 100 and the DUT 102.

In the DUT testing mechanism provided by the present invention, the environmental factors need not to be intently isolated during the test so that the testing procedure is simplified. However, the intrinsic noise of the DUT 102 still needs to be precisely tested to determine the performance of the DUT 102. Because the reference device 100 and the DUT 102 are affected by the same environmental factors during the test, the compensation unit 92 can obtain the environmental factors through the reference device 100 and compensate the signal measured on the DUT 102, so that the environmental factors can be effectively eliminated. The intrinsic noise of the DUT 102 can be obtained through signal processing of the analysis unit 94.

FIG. 2 is a diagram of a compensative acoustic micro-device testing apparatus according to an embodiment of the present invention. Referring to FIG. 2, in order to measure the environmental factors by using the reference device 100, the intrinsic noise of the reference device 100 needs to be obtained first. Thus, a signal of the reference device 100 is first measured in an anechoic standard environment 110. Because most or all environmental factors have been isolated in the standard environment 110, the signal measured on the reference device 100 can be considered as the intrinsic noise of the reference device 100.

Because the reference device 100 itself may be defective, different reference devices 100 may be used and repeatedly tested, and one or an average value of these reference devices may be used as the intrinsic noise of the reference device 100. However, even if the reference device 100 itself is defective, the signal measured is still the intrinsic noise of the reference device 100 and will not affect the test of the DUT. Namely, the intrinsic noise of the reference device 100 is directly obtained in the standard environment 110 in which all environmental factors are isolated through a special technique. However, the actual procedure for obtaining the intrinsic noise is not limited herein.

After the intrinsic noise of the reference device 100 is obtained, the reference device 100 and the DUT 102 are placed on a bearing plate 114 in a testing environment 112 to be tested together. No instrument for isolating any environmental factor is necessary in the testing environment 112.

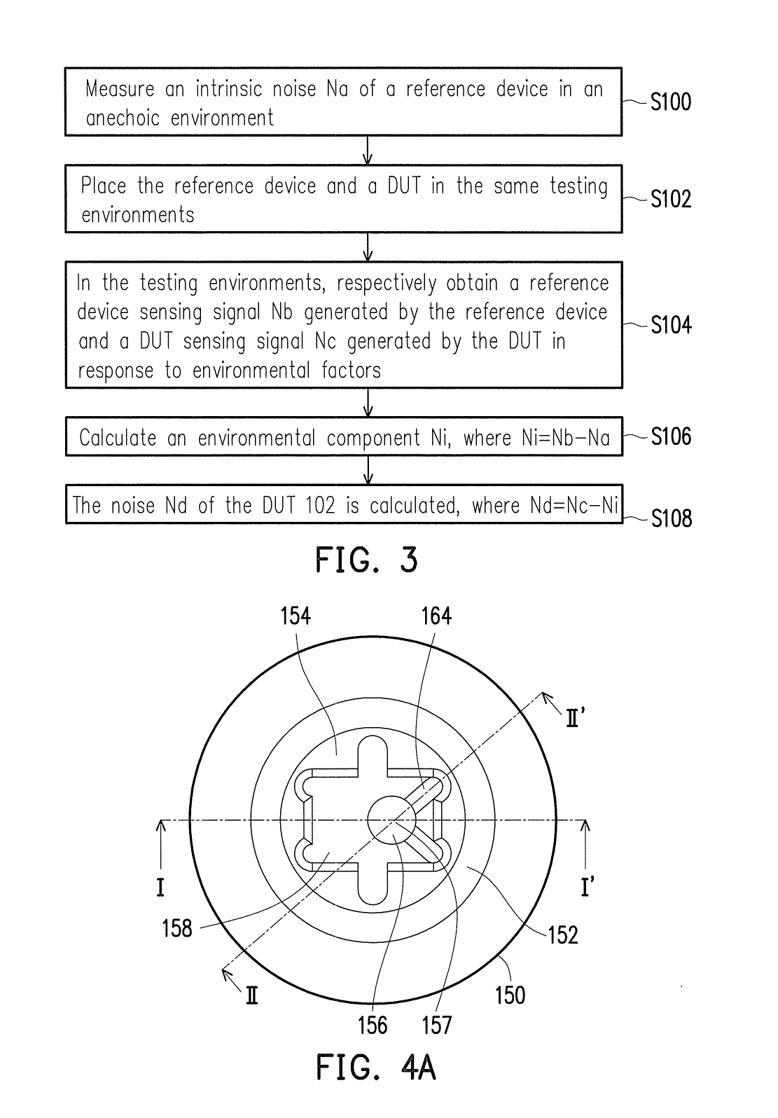

FIG. 3 is a flowchart of a compensative acoustic micro-device testing method according to an embodiment of the present invention. Referring to FIG. 3, based on the testing mechanism illustrated in FIG. 1 and FIG. 2, in step S100, an intrinsic noise Na of a reference device 102 is measured in an anechoic environment. In step S102, the reference device 100 and a DUT 102 are placed in the same testing environments 90 and 112. In step S104, in the testing environments 90 and 112, a reference device sensing signal Nb generated by the reference device 100 and a DUT sensing signal Nc generated by the DUT 102 in response to environmental factors are respectively obtained. In step S106, an environmental component Ni is calculated, where Ni=Nb−Na. In step S108, the noise Nd of the DUT 102 is calculated, where Nd=Nc−Ni.

The calculations performed in steps S106 and S108 are separated. However, these two calculations may also be combined (i.e., Nd=Nc−(Nb−Na)).

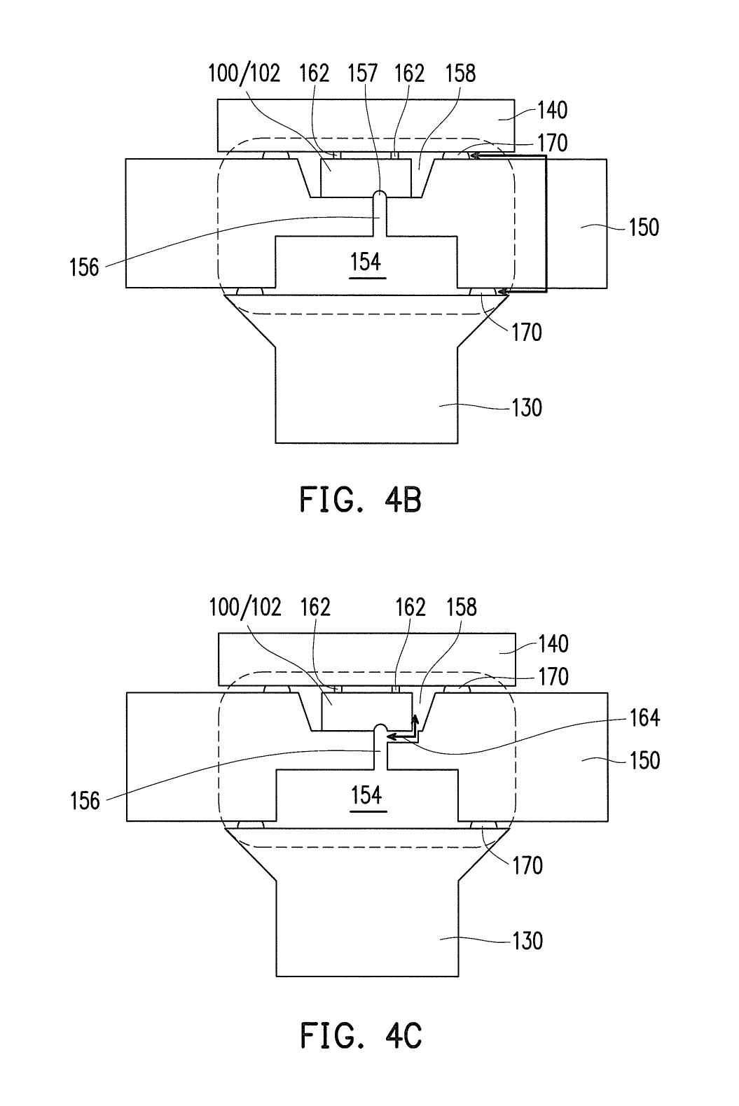

Below, the structure of an acoustic micro-device testing apparatus in a testing environment will be explained. FIG. 4A is a partial top view of an acoustic micro-device testing apparatus according to an embodiment of the present invention. FIG. 4B is a cross-sectional view of the acoustic micro-device testing apparatus in FIG. 4A along line I-I′ according to an embodiment of the present invention. FIG. 4C is a cross-sectional view of the acoustic micro-device testing apparatus in FIG. 4A along line II-IF according to an embodiment of the present invention.

Referring to FIG. 4A, FIG. 4B, and FIG. 4C, the acoustic micro-device testing apparatus in the present exemplary embodiment includes an acoustic device 130, at least one DUT 102, and a bearing plate 150. The acoustic device 130 provides a testing acoustic source. Herein the reference device 100 and the DUT 102 are considered the same DUTs therefore are represented by a single micro-device. Substantially, the bearing plate 150 carries multiple DUTs 102 and reference devices 100. The bearing plate 150 has a first surface and a second surface. The first surface has a chamber 154 sunken into the bearing plate 150, and the second surface has a bearing space 158 sunken into the bearing plate 150 and bearing the DUT 102. The bearing plate 150 further has a main channel 156 connecting the chamber 154 and the DUT 102 and at least one side channel 164 connecting the chamber 154 and the bearing space 158 directly or through the main channel 156. A sound receiving hole 157 on the DUT 102 is corresponding to the main channel 156, and the sound receiving hole 157 directly receives the testing acoustic source. In the present exemplary embodiment, the side channel 164 connects the chamber 154 and the bearing space 158 through the main channel 156 to provide the testing acoustic source to the other side without the sound receiving hole 157 (i.e., the back) of the DUT 102. However, the side channel 164 may also be independent to the main channel 156 and directly connect the chamber 154 and the bearing space 158 as the main channel 156 does.

The side channel 164 is configured to guide the testing acoustic source provided by the acoustic device 130 to the bearing space 158, so that the testing acoustic source is provided to both sides of the DUT 102. Namely, the testing acoustic source is provided to the first side of the DUT 102 through the main channel 156 and to the second side of the DUT 102 through the side channel 164. The acoustic source is provided to both sides of the DUT 102 because the main sound sensing side (i.e., the first side) of the DUT 102 must be tested while any defect on the rear side (i.e., the second side) of the DUT 102, even though not directly sensing any sound, may cause leakage of the sound medium (i.e., air) and accordingly affect the acoustic frequency response or environmental noise absorption of the DUT 102.

There may be one or more (for example, two) side channels 164. Moreover, the route of the side channel 164 and the position from which the side channel 164 enters the bearing space 158 can be estimated and adjusted according to the actual requirement. For example, the side channel 164 can be adjusted to enter the bearing space 158 from a structurally weak point on the backside. The side channel 164 is a part of the bearing plate 150 and can be formed through the processes for forming the chamber 154 and/or the bearing space 158.

A cover unit 140 covers the bearing plate 150 so that the bearing space 158 and the chamber 154 together form a confined space. The DUT 102 is in the confined space. Substantially, to form the confined space, the acoustic micro-device testing apparatus further includes at least one sound barrier ring 170 between any adjacent two of the acoustic device 130, the bearing plate 150, and the cover unit 140. The sound barrier ring 170 can further block some environmental noises. The sound barrier ring 170 is made of a sealing material, such as silicon rubber or an O-ring material.

The first side of the DUT 102 is the sound sensing side and comes with an air hole aligned and connected with the main channel 156. The signal terminal 162 of the DUT 102 is connected to the cover unit 140. The cover unit 140 has a circuit or test probe for supplying a voltage on the DUT 102 and reading signals from the same. These testing instruments are well known to those having ordinary knowledge in the art therefore will not be described herein.

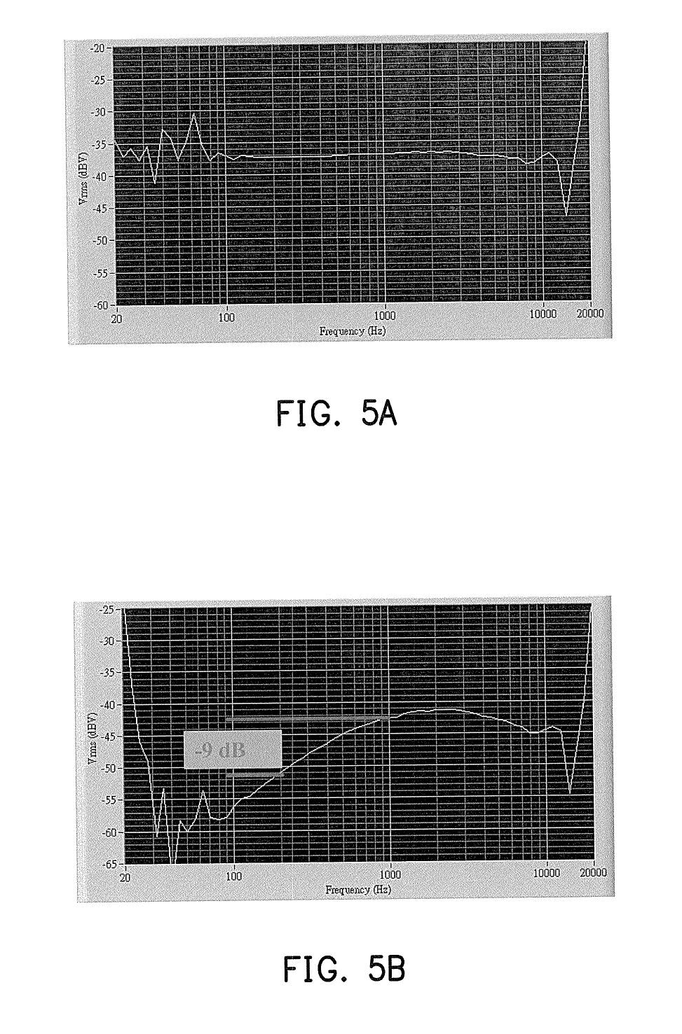

FIG. 5A is a diagram illustrating the acoustic frequency response of a defective acoustic micro-device tested by using a testing apparatus without a side channel according to an embodiment of the present invention. FIG. 5B is a diagram illustrating the acoustic frequency response of a defective acoustic micro-device tested by using a testing apparatus with a side channel according to an embodiment of the present invention.

Referring to FIG. 5A, a DUT 102 may be defective on its rear side, but if the testing apparatus only tests the sound sensing side of the DUT 102 (i.e., the testing apparatus has only a main channel but no side channel), the defect on the rear side may not be detected and the acoustic frequency response signal may indicate that the DUT 102 is good. Referring to FIG. 5B, when the DUT 102 with the defective rear side is tested by using a testing apparatus with a side channel, the acoustic frequency response of the DUT 102 to sound under 5000 Hz shows drastic variations, which means the DUT 102 is defective. Thus, the side channel of the testing apparatus is helpful.

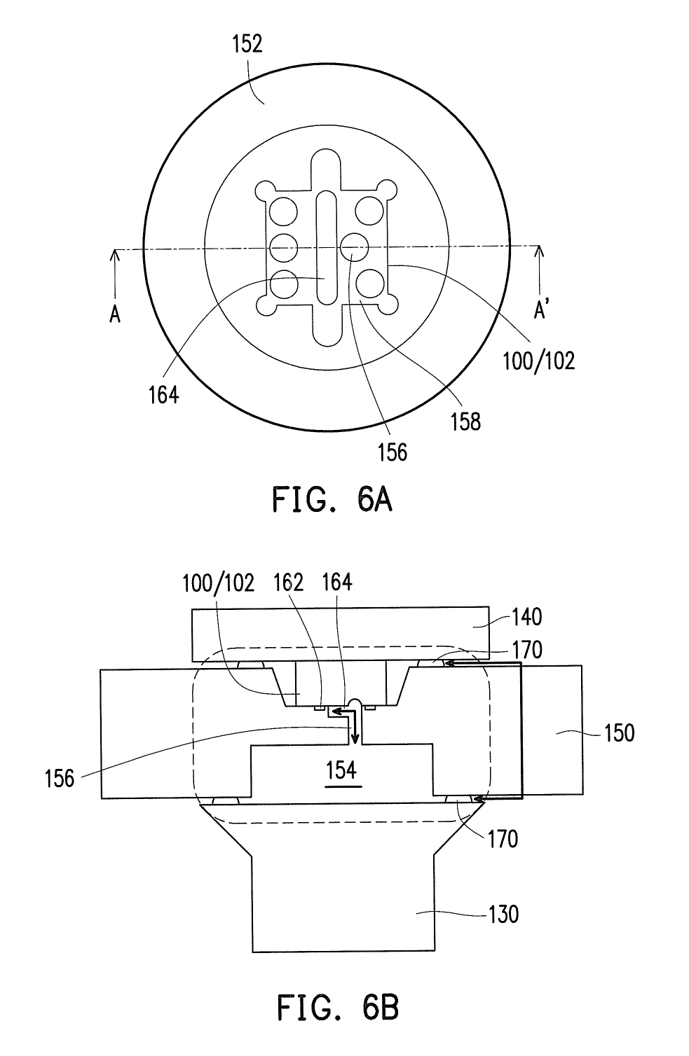

FIG. 6A is a partial top view of an acoustic micro-device testing apparatus according to an embodiment of the present invention. FIG. 6B is a cross-sectional view of the acoustic micro-device testing apparatus in FIG. 6A along line A-A′ according to an embodiment of the present invention.

Referring to FIG. 6A and FIG. 6B, the structure in the present exemplary embodiment is similar to that illustrated in FIGS. 4A-4C. However, in the present embodiment, the signal terminal 162 of the DUT 102 is on the first side of the DUT 102. To avoid intersecting the side channel 164 with the signal terminal 162, the side channel 164 is extended towards the two sides without the signal terminal. However, the disposition concept and function of the side channel 164 remain the same.

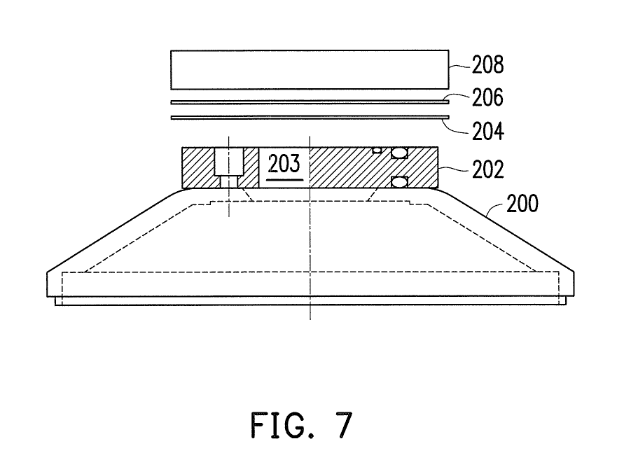

FIG. 7 is an exploded cross-sectional view of a plurality of DUTs on a wafer tested by an acoustic micro-device testing apparatus according to an embodiment of the present invention. Referring to FIG. 7, based on the same mechanism, the bearing plate 150 in FIGS. 4A-4C is expanded to carry a wafer. Accordingly, the acoustic micro-device testing apparatus includes an acoustic device 200, a chamber structure layer 202, a bearing plate 204, a wafer 206, and a cover unit 208. There is a plurality of micro-devices that is not cut or separated yet on the wafer 206. The chamber structure layer 202 and the bearing plate 204 may be integral. However, the chamber structure layer 202 and the bearing plate 204 may also be independent but stacked together. An acoustic source is provided through a large-area channel 203 of the chamber structure layer 202. The bearing plate 204 carriers a reference device. The bearing plate 204 also comes with a side channel for guiding the acoustic source to another side of the wafer 206. The cover unit 208 is stacked to form a confined space for containing the wafer 206. Besides, the cover unit 208 is also served as a signal reading interface such that an external analysis unit can read a signal and calculate the intrinsic noise.

In other words, the design concepts illustrated in FIGS. 4A-4C and FIGS. 6A-6B can be applied to the test of an entire wafer, as shown in FIG. 7, by simply adjusting the sizes and test circuits according to the actual requirement.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An acoustic micro-device testing apparatus, comprising:
an acoustic device, providing a testing acoustic source;
at least one device under test (DUT);
a bearing plate, having a first surface and a second surface, wherein the first surface has a chamber sunken into bearing plate, the second surface has a bearing space sunken into the bearing plate and bearing the at least one DUT, wherein the bearing plate also has a main channel connecting the chamber with the at least one DUT and at least one side channel connecting the chamber with the bearing space directly or through the main channel, wherein the testing acoustic source is provided to a first side of the at least one DUT through the main channel and to a second side of the at least one DUT through the at least one side channel; and
a cover unit, covering the bearing plate so that the bearing space and the chamber form a confined space, wherein the at least one DUT is in the confined space.

2. The acoustic micro-device testing apparatus according to claim 1 further comprising a reference device, wherein the reference device is in the bearing space and receives the testing acoustic source as the at least one DUT does.

3. The acoustic micro-device testing apparatus according to claim 2, wherein the at least one DUT and the reference device are micro-electromechanical systems (MEMS) acoustic sensors of a same structure.

4. The acoustic micro-device testing apparatus according to claim 3, wherein an intrinsic noise of the reference device is already measured in an anechoic environment, so that an environmental noise generated by a testing environment is calculated, and the environmental noise is deducted from a measured signal of the at least one DUT.

5. The acoustic micro-device testing apparatus according to claim 1, wherein a number of the at least one side channel is greater than 1.

6. The acoustic micro-device testing apparatus according to claim 1, wherein the at least one side channel is connected between the main channel and the bearing space.

7. The acoustic micro-device testing apparatus according to claim 1 further comprising at least one sound barrier ring, wherein the sound barrier ring is disposed between any adjacent two of the acoustic device, the bearing plate, and the cover unit.

8. The acoustic micro-device testing apparatus according to claim 1, wherein the at least one DUT is a plurality of acoustic micro-devices under test on a wafer, and the wafer is in the bearing space of the bearing plate.

9. The acoustic micro-device testing apparatus according to claim 1, wherein the testing acoustic source provided to the second side of the at least one DUT through the at least one side channel is an interference caused when a sound under 5000 Hz is detected.

10. An acoustic micro-device testing method applied to the acoustic micro-device testing apparatus of claim 1, comprising:
selecting a reference test device from the at least one DUT, wherein the at least one DUT comprises the reference test device and at least one other DUT;
measuring a reference noise Na of the reference test device in an anechoic environment;
in a same testing environment, providing an acoustic source to the reference test device and at least one other DUT, and measuring sensing signals of the reference test device and the at least one other DUT to the acoustic source to respectively obtain a first noise Nb of the reference test device and a second noise Nc of the at least one other DUT; and
calculating an intrinsic noise Nd of the at least one other DUT, wherein the reference noise Na, the first noise Nb, the second noise Nc, and the intrinsic noise Nd satisfy following relationship:
Nd=Nc−(Nb−Na).

11. The acoustic micro-device testing method according to claim 10, wherein the step of calculating the intrinsic noise Nd of the at least one other DUT comprises:
calculating a reference environmental noise Ni, wherein Ni=Nb−Na; and
deducting the environmental noise Ni from the second noise Nc to obtain the intrinsic noise Nd of the at least one other DUT.

12. The acoustic micro-device testing method according to claim 10, wherein the acoustic source is simultaneously guided to both sides of the reference test device and both sides of the at least one other DUT through at least one channel.

13. The acoustic micro-device testing method according to claim 10, wherein the reference test device and the at least one other DUT are placed in a confined space to reduce environmental noises.

14. An acoustic micro-device testing method, comprising:
selecting a reference test device;
measuring a reference noise Na of the reference test device in an anechoic environment;
in a same testing environment, providing an acoustic source to the reference test device and at least one device under test (DUT), and measuring sensing signals of the reference test device and the at least one DUT to the acoustic source to respectively obtain a first noise Nb of the reference test device and a second noise Nc of the at least one DUT; and
calculating an intrinsic noise Nd of the at least one DUT, wherein the reference noise Na, the first noise Nb, the second noise Nc, and the intrinsic noise Nd satisfy following relationship:
Nd=Nc−(Nb−Na).

15. The acoustic micro-device testing method according to claim 14, wherein the step of calculating the intrinsic noise Nd of the at least one DUT comprises:
calculating a reference environmental noise Ni, wherein Ni=Nb−Na; and
deducting the environmental noise Ni from the second noise Nc to obtain the intrinsic noise Nd of the at least one DUT.

16. The acoustic micro-device testing method according to claim 14, wherein the acoustic source is simultaneously guided to both sides of the reference test device and both sides of the at least one DUT through at least one channel.

17. The acoustic micro-device testing method according to claim 14, wherein the reference test device and the at least one DUT are placed in a confined space to reduce environmental noises.
